(19) United States
(12) Patent Application Publication
(10) Pub. No.: US 2023/0162210 A1
(43) Pub. Date: May 25, 2023

(54) Privacy-Centric Foot Traffic Analysis and Transaction Attribution Using Common User Groups

(71) Applicant: InMarket Media, LLC, Culver City, CA (US)

(72) Inventor: Mark Christopher DIXON, Belmont, CA (US)

(21) Appl. No.: 17/530,768

(22) Filed: Nov. 19, 2021

(51) Int. Cl. G06Q 30/02

(52) U.S. Cl. CPC G06Q 30/0201; G06Q 30/0211

(57) ABSTRACT

Some implementations use the same exposed and unexposed (i.e., control) groups for foot traffic and transaction (e.g., sales) attribution analysis. Some implementations are configured to preserve user data privacy, e.g., the processing entity need not access user-specific sales data that is separately maintained by a third party that provides sales aggregate data.

### FIELD OF THE INVENTION

This disclosure relates generally to devices and systems that utilize user data from multiple sources to assess the effectiveness of marketing campaigns and other advertising content while maintaining data privacy.

### BACKGROUND

Various techniques are used to measure the effectiveness of marketing campaigns, advertising, and other content. It may be useful to analyze the effectiveness of such content using data from multiple sources. For example, it may be useful to analyze advertising content with respect to its impact on foot traffic using data from a foot traffic data collection source and the impact of the advertising content on transactions (e.g., sales) using data from a transaction data collection source. Existing systems may not provide a unified platform for analyzing such different metrics, e.g., using the same exposed and unexposed (i.e., control) groups. Moreover, existing systems may require detailed (and potentially sensitive, private, and/or otherwise user-specific) information from sources that would like to avoid releasing such potentially sensitive, private, and/or otherwise user-specific information to a processing entity.

### SUMMARY

Some implementations disclosed herein use the same exposed and unexposed (i.e., control) groups for foot traffic and transaction (e.g., sales) attribution analysis. Some implementations are configured to preserve user data privacy, e.g., the processing entity need not access user-specific sales data that is separately maintained by a third party that provides aggregate data for the analysis without being required to release user-specific data.

In one exemplary implementation, a processor within a first computing environment executes instructions stored in a computer-readable medium to perform a method. The method determines an exposed group and an unexposed group for both foot traffic analysis and transaction attribution analysis. The exposed group identifies user identities of users exposed to content and the unexposed group identifies user identities of users not exposed to the content. The method transmits the exposed group and unexposed group to a second computing environment, e.g., a data source, that is configured to determine aggregated transaction data for each of the exposed group and the unexposed group. The method receives the aggregated transaction data from the second computing environment for each of the exposed group and the unexposed group and performs a transaction attribution analysis. It also performs a foot traffic analysis. The same exposed group and/or the same unexposed group may be used for the foot traffic analysis and the transaction attribution analysis. The transaction attribution analysis may involve determining an effect of exposure to the content (e.g., incremental lift attributable to ad campaign content) based on the received aggregated transaction data. The foot traffic analysis may involve determining an effect of content on foot traffic.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE FIGURES

These and other features, implementations, and advantages of the present disclosure are better understood when the following Detailed Description is read with reference to the accompanying drawings.

FIG. 1 illustrates an exemplary computing environment according to some implementations disclosed herein.

FIG. 2 illustrates an exemplary process flow that uses the same exposed and unexposed groups for foot traffic analysis and transaction attribution analysis, according to some implementations disclosed herein.

FIG. 3 illustrates another exemplary process flow that uses the same exposed and unexposed groups for foot traffic analysis and transaction attribution analysis, according to some implementations disclosed herein.

FIG. 4 is a flow chart illustrating an exemplary method that uses the same exposed and unexposed groups for foot traffic analysis and transaction attribution analysis, according to some implementations disclosed herein.

FIG. 5 is a block diagram depicting an example hardware implementation.

### DETAILED DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

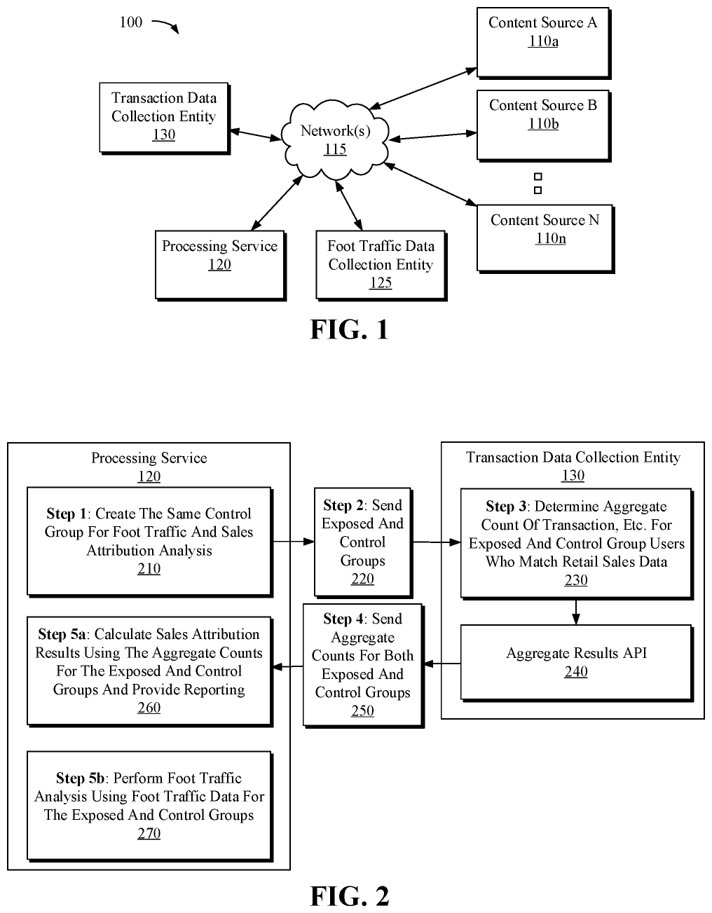

FIG. 1 illustrates an exemplary computing environment 100 in which computation of the effects of content exposure may be measured. In this example, content (e.g., advertisements and/or other advertising campaign content) is provided by content sources A-N 110a-n to potential actors, e.g., customers or users who may convert, for example, by making a purchase from a seller. A transaction data collection entity 130, which may be a seller or an affiliate of a seller as examples, collects information about conversions, sales, and other transactions, e.g., data showing that customer A purchased product C for price D on date E, etc. A foot traffic data collection entity 125, which may be an entity that tracks user locations and movements, collects information about foot traffic, e.g., which stores and other locations associated with a seller user visits in person. Processing service 120 facilitates measurement of the effects of content exposure, e.g., how effective the advertising campaign content provided by each of source A-N 110a were with respect to generating foot traffic and/or resulting in transactions involving the recipients of the advertising campaign content.

Measuring the effects of content exposure may involve measuring advertising-driven foot traffic and/or transactions, e.g., data to attribute incremental store visits and/or sales to marketing campaigns. This may involve a comparison of exposed and unexposed conversion (e.g., visit) rates, where conversion rates are calculated, for example: conversion rate=conversions/users. Incremental lift may be calculated as the percentage increase between the exposed conversion/visit rate (EVR) and the unexposed conversion/visit rate (UVR). Incremental Lift=(EVR−UVR)/UVR.

In some implementations, the processing service 120, in addition to measuring the effects of the content exposure, also performs functions of a data collection entity. In one example, a single entity performs foot traffic data collection and processing services, i.e., processing service 120 and foot traffic data collection entity 125 may be combined within a single entity and/or computing environment.

FIG. 2 illustrates an exemplary process flow that uses the same exposed and unexposed groups for foot traffic and transaction attribution analysis. In this example, a single entity performs foot traffic data collection and processing services, i.e., processing service 120 also performs the functions of the foot traffic data collection entity 125, while transaction data collection is performed by a separate entity, transaction data collection entity 130.

In this example, at block 210, a first step (step 1) is performed by the processing service 120. The processing service 120 creates the same control group for foot traffic analysis and sales attribution analysis. The control groups may be created based on user data, e.g., based on foot traffic data, transaction data, or both foot traffic data and transaction data. Accordingly, in some implementations, processing service 120 may receive some transaction data from the transaction data collection entity 130 that is used to create the control group to be used for both foot traffic analysis and sales attribution analysis. In addition to creating a control group, i.e., identifying unexposed users, the process may also create a single group of exposed users to be used for both foot traffic analysis and sales attribution analysis.

At block 220, a second step (step 2) is performed in which the created control group and/or created exposed group are sent to the transaction data collection entity 130. At block 230, a third step (step 3) is performed by the transaction data collection entity 130 to determine aggregate data, e.g., total sales and/or total users in each of the control and exposed groups who match retail sales data. At block 240, the aggregate data results is externally exposed via an application programming interface (API). At block 250, a fourth step (step 4) is performed in which the aggregate data is sent from the transaction data collection entity 130 to the processing service 120. This may include aggregate counts for both exposed and control groups. This may be in response to an API request from the processing service 120 using aggregate results API 240.

At block 260, a step 5a is performed by the processing service 120 to calculate sales attribution results using the aggregate counts for the exposed and control groups and provide reporting. At block 270, a step 5b is performed by the processing service 120 to perform a foot traffic analysis using foot traffic data for the exposed and control groups. Since, in this example, a single entity performs foot traffic data collection and processing services, there is no need to access an external data collection entity to obtain the foot traffic data needed for and used in the foot traffic analysis.

In the process illustrated in FIG. 2, the same exposed and unexposed groups are used for foot traffic and transaction attribution analysis, providing a unified and potentially more valuable evaluation of the effectiveness of the content with respect to both foot traffic and transactions (e.g., sales in this example). Moreover, the transaction data collection entity 130 is not required to release user-level transaction data to the processing service 120 and thus is enabled to facilitate significant attribution analysis while also maintaining tight control over the privacy of its user data.

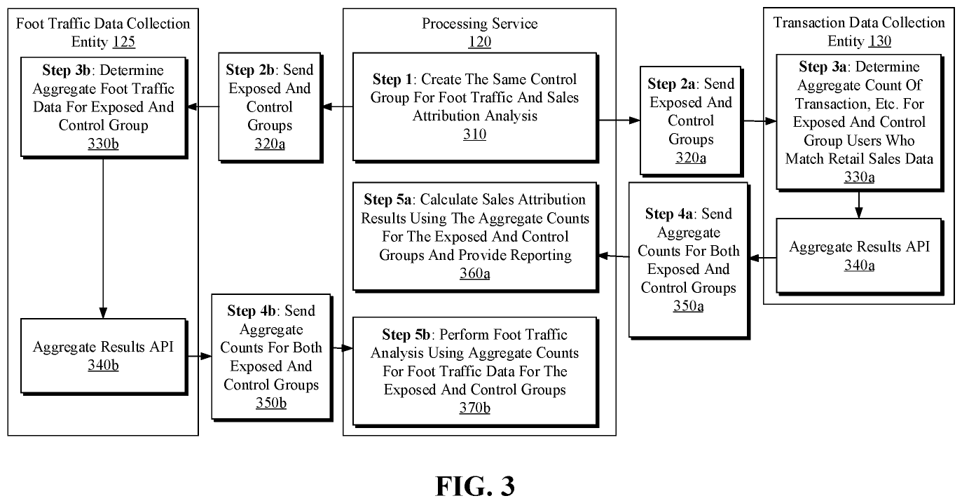

FIG. 3 illustrates another exemplary process flow that uses the same exposed and unexposed groups for foot traffic and transaction attribution analysis. In this example, different respective entities perform foot traffic data collection, transaction data collection, and processing services.

In this example, at block 310, a first step is performed by the processing service 120. Similar to block 210 of FIG. 2, the processing service 120 here creates the same control group for foot traffic analysis and sales attribution analysis. The control groups may be created based on user data, e.g., based on foot traffic data, transaction data, or both foot traffic data and transaction data. Accordingly, in some implementations, processing service 120 may receive some transaction data from the transaction data collection entity 130 and/or some foot traffic data from foot traffic data collection entity 125 that is used to create the control group to be used for both foot traffic analysis and sales attribution analysis. In addition to creating a control group, i.e., identifying unexposed users, the process may also create a single group of exposed users to be used for both foot traffic analysis and sales attribution analysis.

The process in FIG. 3 includes blocks 320a, 330a, 340a, 350a, and 360a performing functions and process elements similar to blocks 220, 230, 240, 250, 260, respectively, to obtain the data needed for and used to perform a transaction attribution analysis using the created control and/or exposed groups. However, since, in FIG. 3, different entities perform foot traffic data collection and processing services, the process illustrated in FIG. 3 differs from that of FIG. 2 with respect to obtaining the data needed for and performance of a foot traffic analysis.

At block 320b, a second step (step 2b), following the creation of the groups, is performed in which the created control group and/or created exposed group are sent to the foot traffic data collection entity 125. At block 330b, a third step (step 3b) is performed by the foot traffic data collection entity 125 to determine aggregate data, e.g., total foot traffic occurrences and/or total users in each of the control and exposed groups who match foot traffic data. At block 340b, the aggregate data results are externally exposed via an application programming interface (API). At block 350b, a fourth step (step 4b) is performed in which the aggregate data is sent from the foot traffic data collection entity 125 to the processing service 120. This may include aggregate counts for both exposed and control groups. This may be in response to an API request from the processing service 120 using aggregate results API 340b. At block 370b, a step 5b is performed by the processing service 120 to perform a foot traffic analysis using foot traffic data for the exposed and control groups.

In the process illustrated in FIG. 3, the same exposed and unexposed groups are used for foot traffic and transaction attribution analysis, providing a unified and potentially more valuable evaluation of the effectiveness of the content with respect to both foot traffic and transactions (e.g., sales in this example). Moreover, the transaction data collection entity 130 and the foot traffic data collection entity 125 are not required to release user-level data to the processing service 120 and thus are enabled to facilitate significant analysis while also maintaining tight control over the privacy of user data.

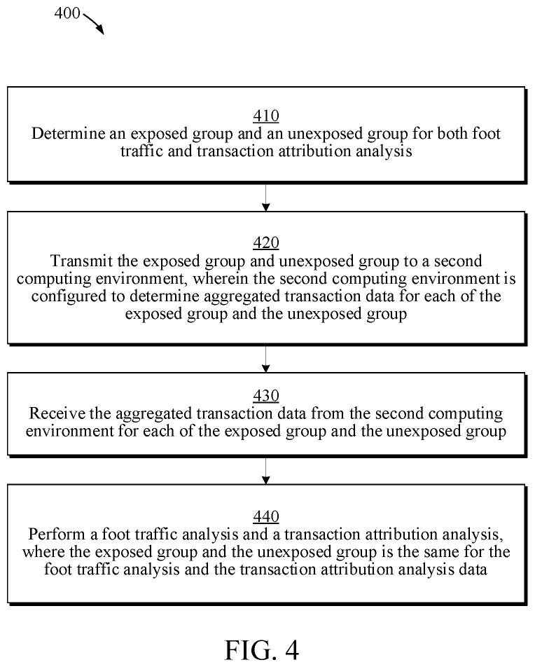

FIG. 4 is a flow chart illustrating an exemplary method 400 that uses the same exposed and unexposed groups for foot traffic and transaction attribution analysis. The exemplary method 400 can be implemented via a computing device, for example, by using a processor to execute instructions stored in a non-transitory computer-readable medium. Reference to the method 400 being performed by a computing device includes the method 400 being performed by one or more computing devices and/or using one or more processors.

At block 410, the method 400 determines an exposed group and an unexposed (i.e., control) group for both foot traffic and transaction attribution analysis. The exposed group identifies user identities of users exposed to content and the unexposed group identifies user identities of users not exposed to the content. For example, this may involve a processing service 120 create a matched unexposed (i.e., control) group using foot traffic data for a marketing campaign. The data may correspond to exposure/non-exposure during a defined time window. Accordingly, the exposed group data and unexposed group data correspond to a specified time period.

At block 420, the method 400 transmits the exposed group and unexposed group to a second computing environment. The second computing environment is configured to determine aggregated transaction data for each of the exposed group and the unexposed group. In some implementations, the aggregated transaction data is aggregated user-level conversion data and/or user-level sales data. In some implementation, the aggregated transaction data includes an aggregated exposed transaction value, an aggregated number of exposed users, an aggregated unexposed transaction value, and an aggregated number of unexposed users. In some implementations, the aggregate data includes aggregate counts of exposed conversions, exposed users, unexposed conversions, unexposed users, standard deviation of conversion for the exposed users, and/or standard deviation of conversion for the unexposed users. The aggregate data may include aggregate counts of, sub-dimension data, including exposed conversions, exposed users, unexposed conversions, and unexposed users. The aggregate data may include matched rate data.

The second computing environment is distinct from the first computing environment, e.g., provided via different computing devices and/or operated by or under the control of different entities. In some implementations, the first computing environment comprises information that is confidentially maintained for a first business entity and the second computing environment comprises information that is confidentially maintained for a second business entity different than the first business entity.

At block 430, the method 400 receives the aggregated transaction data from the second computing environment for each of the exposed group and the unexposed group. The received aggregated transaction data may exclude user-level transaction data and such data may be unavailable to the first computing environment/processing entity.

At block 440, the method 400 performs a foot traffic analysis and a transaction attribution analysis. The exposed group and/or the unexposed group may be the same for the foot traffic analysis and the transaction attribution analysis. The transaction attribution analysis may involve determining and comparing exposed and unexposed conversion rates. The transaction attribution analysis may involve determining an effect of exposure to the content (e.g., incremental lift attributable to ad campaign content) based on the received aggregated transaction data. The transaction attribution analysis may involve determining and comparing exposed and unexposed conversion rates.

Incremental lift may be calculated as a percentage increase between an exposed transaction rate (ETR) and an unexposed transaction rate (UTR). The percentage increase may be calculated using four aggregate numbers: exposed transactions, exposed users, unexposed transactions, and unexposed users.

In the process illustrated in FIG. 4, the same exposed and unexposed groups are used for foot traffic and transaction attribution analysis, providing a unified and potentially more valuable evaluation of the effectiveness of the content with respect to both foot traffic and transactions (e.g., sales in this example). Moreover, the second computing environment is not required to release user-level transaction data and thus is enabled to facilitate significant attribution analysis while also maintaining tight control over the privacy of its user data. In some implementations, the first computing environment does not receive to the user-level transaction data, e.g., raw customer-level sales data does not have to leave the second party environment. The user-level transaction data may be unavailable to the first computing environment. In some implementations, user-level transaction data is exclusively maintained within the second computing environment.

In some implementations, the data that is shared with the first computing environment comprises limited identifier-level data but does not reveal conversion-specific data. For example, such data may identify that a customer is within the 40th percentile without revealing that that the customer spent $50.

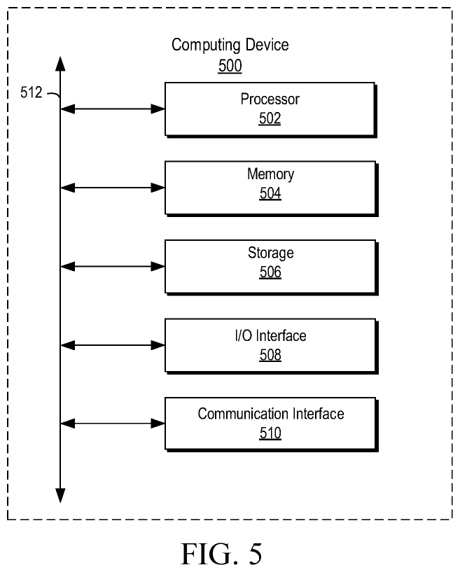

FIG. 5 is a block diagram depicting an example hardware implementation for the devices described in FIG. 1. Each such device 500 may include a processor 502 that is communicatively coupled to memory 504 and storage 506 and that executes computer-executable program code and/or access information stored in the memory 504 and storage 506. The processor 502 may comprise a microprocessor, an application-specific integrated circuit (“ASIC”), a state machine, or other processing device. The processor 502 can include any of a number of processing devices, including one. Such a processor 502 can include or may be in communication with a computer-readable medium storing instructions that, when executed by the processor, cause the processor to perform the operations described herein.

The memory 504 and storage 506 can include any suitable computer-readable medium. The computer-readable medium can include any electronic, optical, magnetic, or other storage device capable of providing a processor with computer-readable instructions or other program code. Non-limiting examples of a computer-readable medium include a magnetic disk, memory chip, ROM, RAM, and ASIC, a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++ C#, Visual Basic, Java, Python, Perl, and JavaScript.

The device 500 may also comprise a number of external or internal devices such as input or output devices. For example, the device 500 may have input/output (“I/O”) interface 508 that can receive input from input devices or provide output to output devices. A bus 512 can also be included in the device 500. The bus 512 can communicatively couple one or more components.

The device 500 can also include at least one network interface device or other communication interface 510. The communication interface 500 can include any device or group of devices suitable for establishing a wired or wireless data or telephone connection to one or more networks. Non-limiting examples of a network interface device include an Ethernet network adapter, a modem, and/or the like. A device can transmit messages as electronic or optical signals.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not be described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more Implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

The foregoing description and summary of the invention are to be understood as being in every respect illustrative and exemplary, but not restrictive, and the scope of the invention disclosed herein is not to be determined only from the detailed description of illustrative Implementations but according to the full breadth permitted by patent laws. It is to be understood that the Implementations shown and described herein are only illustrative of the principles of the present invention and that various modification may be implemented by those skilled in the art without departing from the scope and spirit of the invention.

What is claimed is:

1. A method comprising:
at a processor within a first computing environment:
determining an exposed group and an unexposed group for both foot traffic and transaction attribution analysis, the exposed group identifying user identities of users exposed to content and the unexposed group identifying user identities of users not exposed to the content;
transmitting the exposed group and unexposed group to a second computing environment, wherein the second computing environment is configured to determine aggregated transaction data for each of the exposed group and the unexposed group, wherein the second computing environment is distinct from the first computing environment;
receiving the aggregated transaction data from the second computing environment for each of the exposed group and the unexposed group; and
performing a foot traffic analysis and a transaction attribution analysis, wherein the exposed group and the unexposed group is the same for the foot traffic analysis and the transaction attribution analysis, wherein the transaction attribution analysis comprises determining an effect of exposure to the content based on the received aggregated transaction data

2. The method of claim 1, wherein the first computing environment does not receive user-level transaction data.

3. The method of claim 1, wherein user-level transaction data is exclusively maintained within the second computing environment.

4. The method of claim 1, wherein the exposed group and the unexposed group are created based on foot traffic data.

5. The method of claim 1, wherein the exposed group and the unexposed group are created based on transaction data.

6. The method of claim 1, wherein the exposed group and the unexposed group are created based on foot traffic data and transaction data.

7. The method of claim 1, wherein the exposed group data and unexposed group data correspond to a specified time period.

8. The method of claim 1, wherein the aggregated transaction data is aggregated user-level sales data.

9. The method of claim 1, wherein the aggregated transaction data comprises:
an aggregated exposed transaction value;
an aggregated number of exposed users;
an aggregated unexposed transaction value, and
an aggregated number of unexposed users.

10. The method of claim 1, wherein the received aggregated transaction data excludes user-level transaction data, wherein the user-level transaction data is unavailable to the first computing environment.

11. The method of claim 1, wherein the transaction attribution analysis comprises determining and comparing exposed and unexposed conversion rates.

12. The method of claim 1, wherein determining the effect of exposure to the content comprises determining an incremental lift attributable to ad campaign content based on the received aggregated transaction data.

13. The method of claim 12, wherein the incremental lift is calculated as a percentage increase between an exposed transaction rate (ETR) and an unexposed transaction rate (UTR).

14. The method of claim 12, wherein the incremental lift is calculated based on:
an aggregated exposed transaction value;
an aggregated number of exposed users;
an aggregated unexposed transaction value, and
an aggregated number of unexposed users.

15. The method of claim 1, wherein:
the first computing environment comprises information that is confidentially maintained for a first business entity; and
the second computing environment comprises information that is confidentially maintained for a second business entity different than the first business entity.

16. An electronic device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the system to perform operations comprising:
determining an exposed group and an unexposed group for both foot traffic and transaction attribution analysis, the exposed group identifying user identities of users exposed to content and the unexposed group identifying user identities of users not exposed to the content;
transmitting the exposed group and unexposed group to a second computing environment, wherein the second computing environment is configured to determine aggregated transaction data for each of the exposed group and the unexposed group, wherein the second computing environment is distinct from the first computing environment;
receiving the aggregated transaction data from the second computing environment for each of the exposed group and the unexposed group; and
performing a foot traffic analysis and a transaction attribution analysis, wherein the exposed group and the unexposed group is the same for the foot traffic analysis and the transaction attribution analysis, wherein the transaction attribution analysis comprises determining an effect of exposure to the content based on the received aggregated transaction data.

17. The electronic device of claim 16, wherein the exposed group and the unexposed group are created based on foot traffic data.

18. The method of claim 16, wherein the exposed group and the unexposed group are created based on transaction data.

19. The method of claim 16, wherein the aggregated transaction data comprises:
an aggregated exposed transaction value;
an aggregated number of exposed users;
an aggregated unexposed transaction value, and
an aggregated number of unexposed users.

20. A non-transitory computer-readable storage medium, storing program instructions executable via one or more processors to perform operations comprising:
determining an exposed group and an unexposed group for both foot traffic and transaction attribution analysis, the exposed group identifying user identities of users exposed to content and the unexposed group identifying user identities of users not exposed to the content;
transmitting the exposed group and unexposed group to a second computing environment, wherein the second computing environment is configured to determine aggregated transaction data for each of the exposed group and the unexposed group, wherein the second computing environment is distinct from the first computing environment;
receiving the aggregated transaction data from the second computing environment for each of the exposed group and the unexposed group; and
performing a foot traffic analysis and a transaction attribution analysis, wherein the exposed group and the unexposed group is the same for the foot traffic analysis and the transaction attribution analysis, wherein the transaction attribution analysis comprises determining an effect of exposure to the content based on the received aggregated transaction data.
